(19) United States
(12) Patent Application Publication
(10) Pub. No.: US 2006/0011596 A1
(43) Pub. Date: Jan. 19, 2006

(54) Screen printed heater for vehicle elements

(76) Inventors: Larry Lee Sharp, Douglas, MI (US); Michael Anthony Schwaller, Elkhart, WI (US); Ralph A. Hausler, Plymouth, WI (US)

Correspondence Address: FOSTER, SWIFT, COLLINS & SMITH, P.C., 313 SOUTH WASHINGTON SQUARE, LANSING, MI, 48933, US

(21) Appl. No.: 10/975,026

(22) Filed: Oct. 27, 2004

Related U.S. Application Data
(60) Provisional application No. 60/515,047, filed on Oct. 28, 2003.

(51) Int. Cl. B60L 1/02

(52) U.S. Cl. 219/203

(57) ABSTRACT

A layered screen printed conductive pattern is applied to a flexible surface for defrosting, such as in windows. A narrowed buss pattern coupled to a hexagonal grid of conductive silver is applied to vinyl to heat and defrost.

### RELATED APPLICATION

This application claims the benefit of U.S. Provisional Patent Application Ser. No. 60/515,047, filed 28 Oct. 2003, and entitled “Screen Printed Window Heater.”

### BACKGROUND OF THE INVENTION

Rear window heaters are fairly common in vehicles with glass rear windows. They typically consist of horizontal electrically conductive lines that are applied to the window and spaced apart so as to not impede vision. These conductive lines generate heat when voltage is applied causing localized heating of the glass. The heat spreads through the glass via thermal conduction warming the surface of the glass to melt ice, snow, and frost or to defog the glass under certain ambient conditions. These heaters usually achieve fairly high temperatures to clear the glass in the shortest time possible. Rear windows of this type are typically made of tempered glass and can withstand the high temperatures generated by the heating lines. The glass is also reasonably conductive (thermal) to allow the heat to spread from the heating lines to the entire surface of the glass.

The conductive materials used to form the heating lines are typically processed at relatively high temperatures to fuse them to the glass and to provide high electrical conductivity. High electrical conductivity allows the use of physically thin heating lines, which help to reduce any impact on vision.

Flexible plastic rear windows as used in some convertible tops have some constraints that prevent the use of this type of heater. These constraints include low melting point of the clear plastic (high heating temperatures could melt the vinyl or high process temperatures could damage the vinyl); low heat distortion temperature for the vinyl (heated lines could distort the window and affect vision); and low thermal conductivity (relative to glass) can prevent full defrosting or deicing. Therefore, it is desirable for a flexible heating grid to match the flexibility of the window according to the thermal prerequisites identified above.

### SUMMARY OF THE INVENTION

The invention comprises a window heating grid for vehicles with convertible tops that use plastic rear windows (typically made from vinyl). The heating grid has unique features that allow it to efficiently melt ice and frost from the window while at the same time preventing overheating that could damage the clear plastic. The heater grid pattern also provides adequate visibility through the rear window.

### BRIEF DESCRIPTION OF THE DRAWINGS

FIG. 1 is a front view of a window with a heating grid.

FIG. 2 is a front view of a portion of a window showing an electrical connection.

FIG. 3 is a rear view of a portion of a window showing an electrical connection.

FIG. 4 is a view of an alternate embodiment of the present invention, the heating grid applied to a cover for a vehicle light.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention.

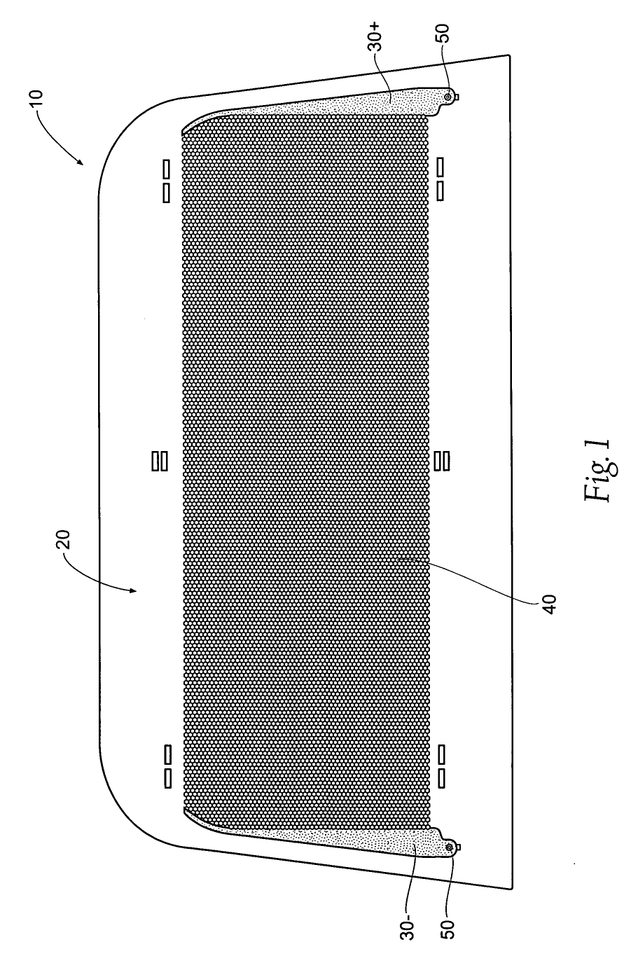

Referring now to FIG. 1, a front view of a window 10 with a heating grid 40 is shown. The window 10 comprises a cut-out pattern 20 of vinyl or other suitable flexible material, which can be configured in any shape, according to user preference, tailored to fit an existing window pattern. The window 10 can be supplied with hook and loop fastener, or a zipper, or any other means for connecting the window 10 to the user's needs, such as a rear window of a car.

The window 10 has positive and negative electrical connections 30+ and 30−, powered through opposing electrical connectors 50 between which electrical current can flow across the heating grid 40.

Preferably, the heating grid 40 is comprised of interconnected hexagonal shapes, facilitating continuation of current across the remainder of the grid if any of the heating grid should be compromised due to physical disconnection.

A preferred means for applying the grid 40 and electrical connections 30+ and 30− to the window 10 is through layered application of conductive material, such as conductive silver, or silver and graphite, or any other conductive material that may be layered with screen printing. Layering is preferable in order to build up enough electrical capacity to allow the grid 40 to effectively thaw frost or ice.

Use of low temperature cure polymer based conductive inks to provide the heating grid 40 is preferred, as is screen printing of conductive inks onto the clear plastic window 10.

It is preferable to provide layering in the following manner; first, to apply a clear screen printed undercoat to the window 10 to enhance successive adhesion of the conductive inks to the vinyl window surface 10. Next, the conductive ink is applied successively until the desired thickness for the grid 40 is achieved. Next, a clear screen printed overcoat is applied on top of the conductive ink to protect the electrically conductive circuit or grid 40 against mechanical abrasion and environmental corrosion.

It is desirable to use hexagons or similar shapes for the conductive lines that comprise the grid 40 in order to bring the heating lines close together without impeding vision. This pattern 40 also provides distributed heating to compensate for the low thermal conductivity of vinyl.

This hexagonal pattern can also be easily scaled to adapt the performance of the heater for various applications as necessary. This also provides a pattern wherein all of the conductive lines may be utilized equally in the electrical circuit to provide uniform heating and to provide maximum electrical conductivity.

It is preferable to provide a heating pattern that facilitates rapid de-icing (10-15) minutes while not overheating the vinyl substrate, and that is not easily damaged via abrasion or scratching. This requires multiple redundant circuits so that loss of one element does not significantly affect the entire heating area.

It is also preferable to provide heating lines that are as physically flexible as the vinyl window so that the window can be rolled folded without damaging the heater.

Referring still to FIG. 1, main electrical buses, or electrical connections 30+ and 30− are provided to power the heating grid 40. These buses are preferably very conductive relative to the main grid, in order to not constrain electrical flow to the grid 40. In the case of the illustrated grid 40, the main buses are triple coated (3 times as thick) to make them more conductive. The alternative construction would be to make the buses wider to increase conductivity. However, this could impede vision to an unacceptable degree.

As can be seen, the electrical connections 30+ and 30− are preferably wider at the bottom near electrical connections 50, narrowing towards the top. This pattern assists more uniform electricity across the grid 40.

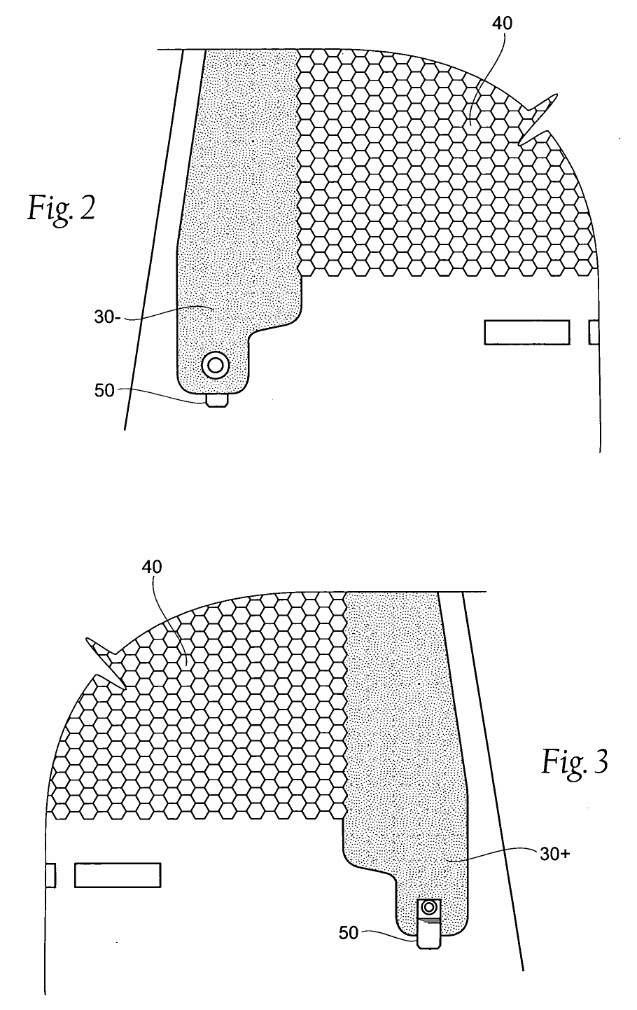

Referring now to FIG. 2, electrical connections to the grid are made via an electrical connector 50 (such as tin plated brass) that is riveted mechanically attached to the surface of the main buses electrical connections 30+ and 30−. This connector 50 is attached using multiple rivets to distribute the relatively high electrical current into the main bus without overheating the bus and/or the vinyl substrate.

Tin plating of the connectors 50 prevents surface corrosion of the brass material that would reduce its conductivity. FIG. 3 shows a rear view of a portion of a window showing an electrical connection.

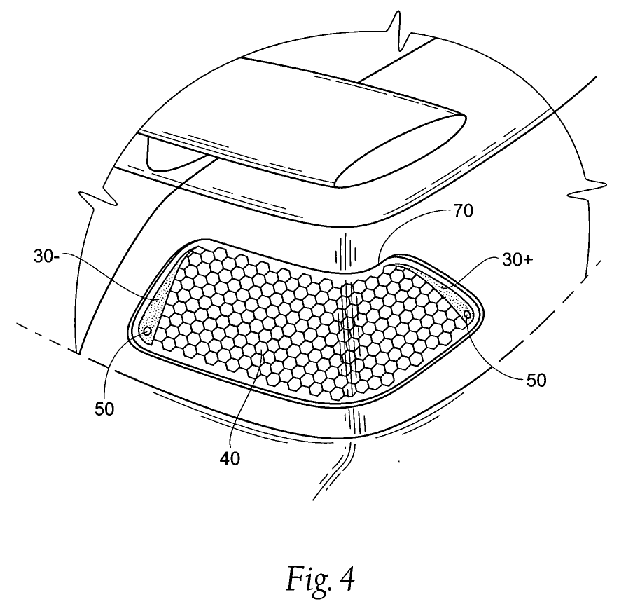

An alternate embodiment of the present invention is shown in FIG. 4. FIG. 4 depicts the alternative embodiment applied to a known automobile lamp cover 70. Prior art automobile lamps were primarily lit with light bulbs. Increasingly, LED lights are being used which do not provide as much heat to the lamp cover 70. So, in cold climates, the heat generated by LED lights alone might not be enough to thaw ice or snow or frost that may build up on the cover 70. The inside surface of the plastic cover of the lamp 70 is covered with a heating grid 40 of hexagonal shapes as described above. Although an automobile turn signal is shown it is also contemplated that the forgoing description could be applied to many outdoor LED applications including but not limited to a traffic signal and other automobile or motorcycle lights. In the preferred embodiment, the heating grid 40 will be sized so that individual LED elements (not shown) will be sized and positioned so that the grid 40 is not obstructive of the light intended to emanate from the LED pattern.

In any embodiment, it is preferred that the electrical connections 50 be coupled to the main electrical system of the vehicle, as would prior art window heaters or lights or LEDs.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

We claim:

1. A heating element for a vehicle comprising:
an electrically conductive heating grid applied to a vehicle element;
the heating grid comprising a plurality of layers of conductive material;
the heating grid being applied in a hexagonal pattern;
a positive electrical connection;
a negative electrical connection;
the positive electrical connection and the negative electrical connection being on opposing ends of the heating grid; and
a voltage applied across the heating grid.

2. The heating element according to claim 1, wherein said vehicle element is a flexible rear window.

3. The heating element according to claim 2, wherein said flexible rear window comprises vinyl.

4. The heating element according to claim 1, wherein said vehicle element is a lamp cover.

5. The heating element according to claim 1, wherein said heating grid is deposited on said vehicle element by a screen printing process.

6. The heating element according to claim 1, wherein said heating grid is formed of at least one of silver and graphite.
